(19) United States
(12) Patent Application Publication
(10) Pub. No.: US 2006/0060092 A1
(43) Pub. Date: Mar. 23, 2006

(54) Screw press head detector

(76) Inventor: Chun-Nan Wu, Kaohsiung County (TW)

Correspondence Address: BIRCH STEWART KOLASCH & BIRCH, PO BOX 747, FALLS CHURCH, VA, 22040-0747, US

(21) Appl. No.: 10/942,989

(22) Filed: Sep. 17, 2004

(51) Int. Cl. B30B 15/14

(52) U.S. Cl. 100/48

(57) ABSTRACT

The present invention discloses a screw press head detector, which comprises an eccentric mechanism for driving an ascending/descending rod module to press a probe module downward and using a groove of the prove rotary head to rotate and fix a screw at the same angle with the polygonal hole of the screw in order to facilitate the detection of the depth of the polygonal hole of the screw, and push the fixed rod upward to fix the screw and facilitate the measurement of the length, thread pitch, screw thread angle and thread pitch between the bottom of the screw head to the screw thread as to constitute a screw press head detector featuring the simple operation procedure, accurate measurement, capability of detection several items and time saving.

### FIELD OF THE INVENTION

The present invention relates to a screw press head detector, more particularly to a screw press head detector having the simple operation procedure, accurate measurement, capability of detection several items and time saving features.

### BACKGROUND OF THE INVENTION

At present, there are various types of screw press detectors (as shown in FIGS. 1 and 2) sold in the market. Although these screw press detectors have the functions of measuring the length, size, and thread depth required by users, they still have the following drawbacks:

1. When the prior-art screw press head detector detects screws, a motor is rotated to align the position of a sink hole, but the screw is under the rotation and the screw thread cannot be measured accurately and determined whether or not it meets the user's requirement.

2. Since the bottom of the screw head of the prior-art screw press head detector is in touch with a fixed board, therefore when the screw is under rotation, the contact of the bottom of the screw head and the fixed board produces friction. As a result, the fixed board is worn and damage easily after its use for a long time, and causing errors and inaccuracy to the measurement.

3. When the prior-art screw press head detector detects the depth of the sink hole at the top of the screw head, the probe is driven by a belt and a motor to move vertically up and down to measure the depth of the sink hole. The belt is moved reciprocally to detect the depth, but the belt will be worn and lose its elasticity easily after its use for a long time. Therefore, the belt cannot drive the probe properly anymore, which causes errors.

4. When the prior-art press head detector detects the length, size and thread depth of the screw, it is necessary to go through many complicated steps and cannot complete detecting all required functions at a time. Furthermore, the detection involves too many components and thus makes the assembly too complicated.

5. The prior-art screw press head detector uses the rotation of a cam to drive the detector to move vertically up and down, but the rotation of the cam produces friction which will wear out and damage the cam after its use for a long time. As a result, the detector cannot be driven to a fixed point and gives rise to errors. Further, indented holes may be produced by the friction of the cam after a long period of time, and thus affecting the accuracy of the detection.

### SUMMARY OF THE INVENTION

The primary objective of the present invention is to overcome the foregoing shortcoming and avoid the existing deficiency by providing a screw press head detector that can provide a precise, simple-to-operate and time-saving measurement and measure different options at the same time. The screw press head detector comprises an eccentric mechanism, an ascending/descending rod module, a fixed rod module and a probe module; wherein the upper and lower ends of the ascending/descending rod module are coupled to the eccentric mechanism and the fixed rod respectively by screws. The eccentric mechanism is pulled downward to drive the ascending/descending rod module at the top of a pulling rod of the eccentric mechanism to move downward and push another ascending/descending rod module to move upward as to press the connected fixed rod upward against the bottom of the screw, and press the probe module downward into a hole on the screw head. The testing screw head is rotated at the same angle and fixed with the hole of the screw by a groove of the probe rotary head.

### BRIEF DESCRIPTION OF THE DRAWINGS

FIG. 1 is an illustrative view of a prior-art screw press head detector.

FIG. 2 is another illustrative view of a prior-art screw press head detector.

FIG. 3 is a perspective view of the screw press head detector of the present invention.

FIG. 4 is an illustrative view of the movement of the screw press head detector according to the present invention.

FIG. 5 is another illustrative view of the movement of the screw press head detector according to the present invention.

FIG. 6 is an exploded view of the probe module according to the present invention.

FIG. 7 is a perspective view of the probe module according to the present invention.

FIG. 8 is an illustrative view of the movement of the probe module according to the present invention.

FIG. 9 is an illustrative view of the movement of fixing the screw according to the present invention.

FIG. 10 is an illustrative view of the image of the screw according to the present invention.

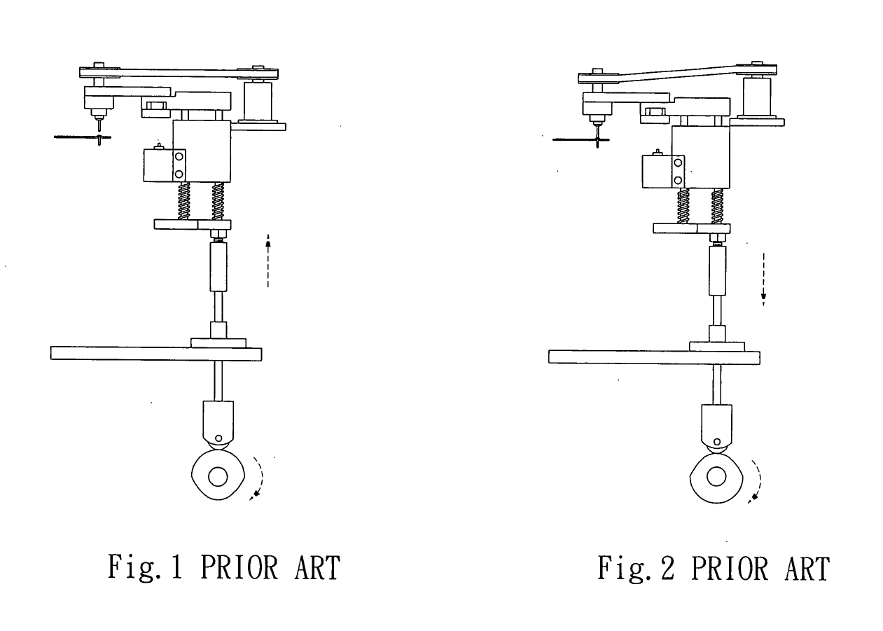

### DETAILED DESCRIPTION OF THE PREFERRED EMBODIMENTS

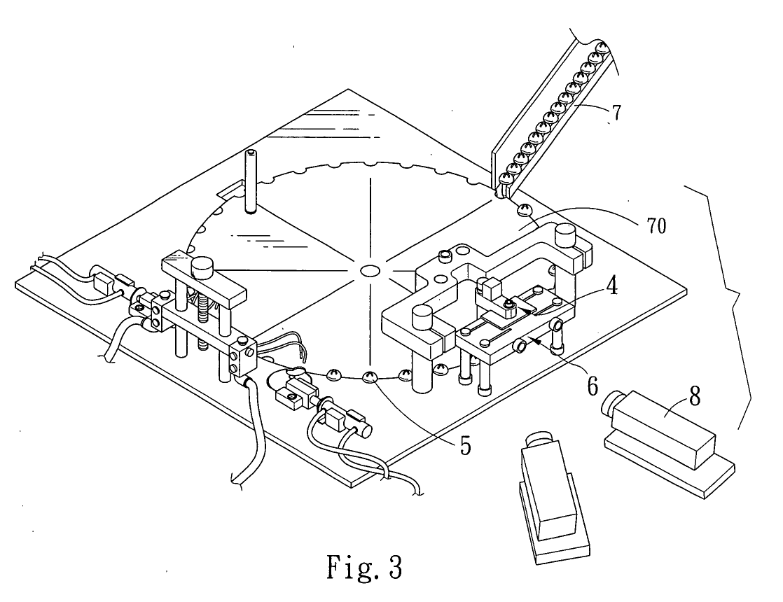

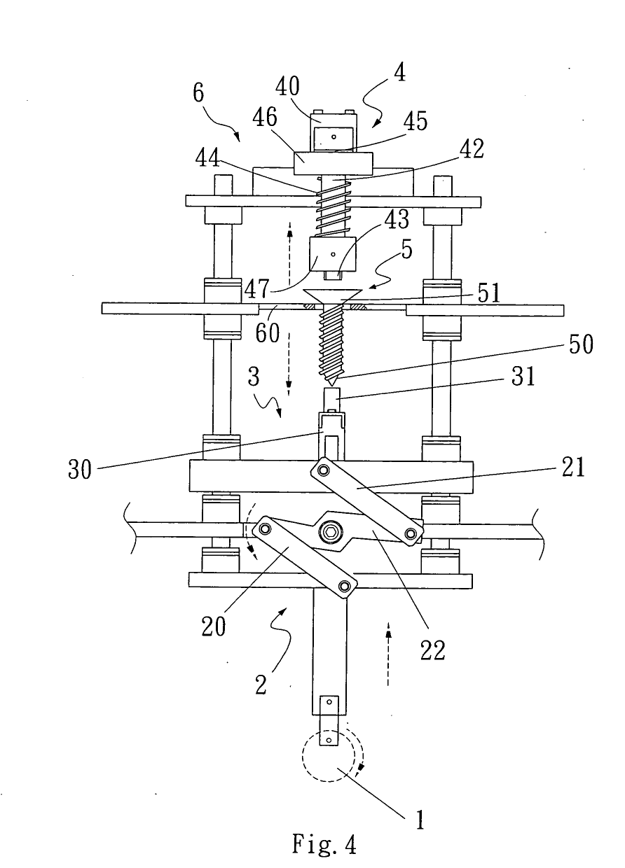

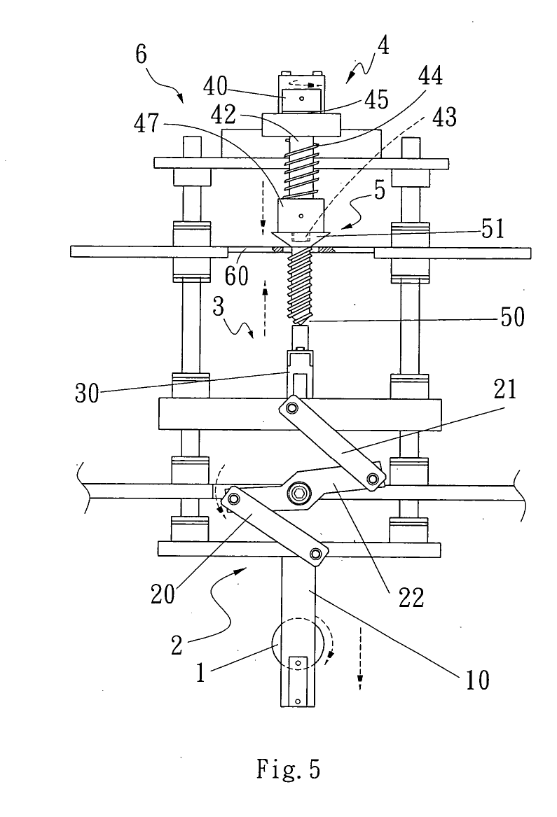

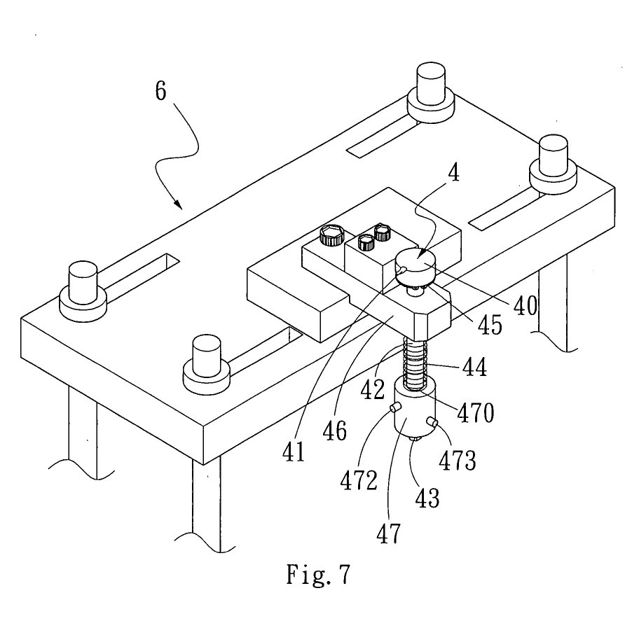

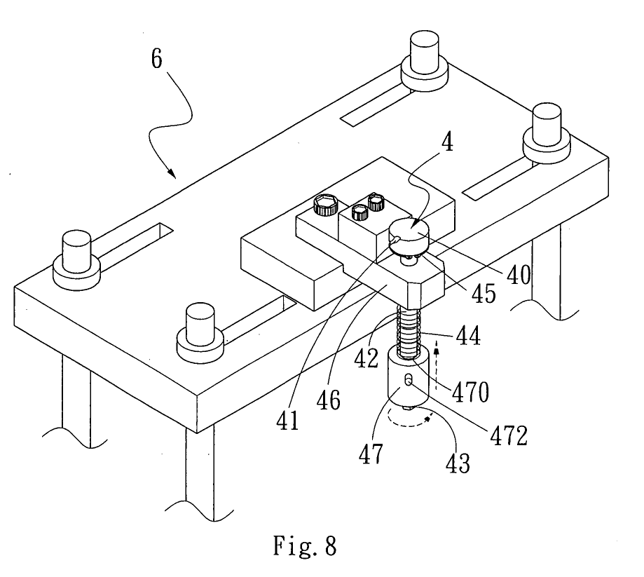

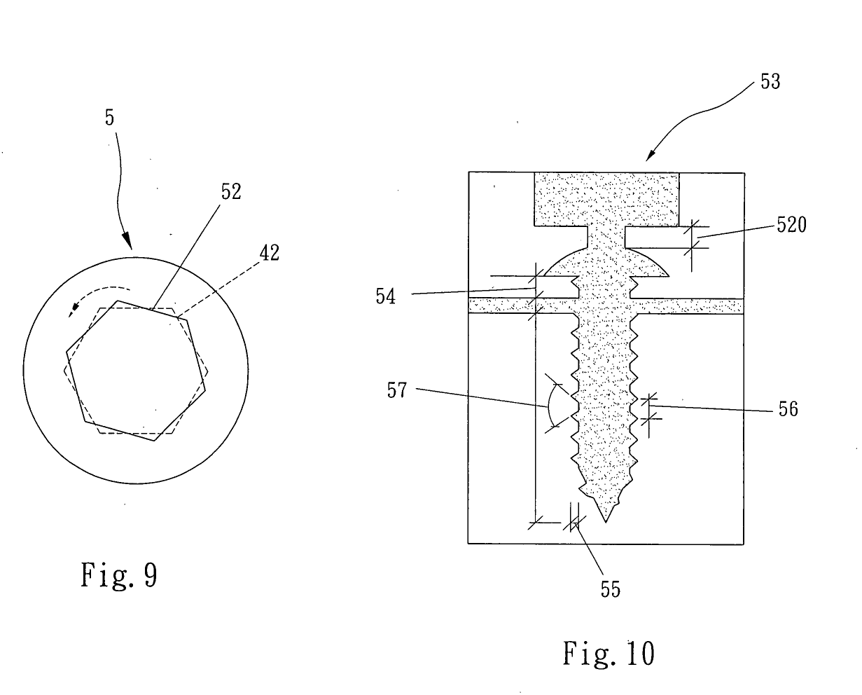

Please refer to FIGS. 3 and 4 for the screw press head detector according to the present invention. The detector comprises an eccentric mechanism 1, an ascending/descending rod module 2, a fixed rod module 3 and a probe module 4; wherein the eccentric mechanism 1 is driven to rotate a pulling rod 10 of the eccentric mechanism 1 as to pull the ascending/descending rod 20 down and push another set of ascending/descending rod 21 up, such that the fixed rod 31 is pressed upward against the bottom of a screw 50, and the probe module 4 is pressed downward into a polygonal hole 52 on the screw head 51 as shown in FIGS. 4, 5 and 9. The screw testing head 40 is rotated and fixed at the same angle with a polygonal hole 52 on the screw 5 (as shown in FIG. 9) by a groove 41 on the probe rotary head 40 (as shown in FIGS. 7 and 8).

The forgoing eccentric mechanism 1 is situated on one side of a base 60 of the screw press head detector 6 and coupled securely to the pulling rod 10 of the eccentric mechanism 1.

The ascending/descending rod module 2 comprises two ascending/descending rods 20, 21 and a ascending/descending pulling rod 22, and each end of the ascending/descending rod 22 is securely coupled to the ascending/descending rod 20, 21, and one end of the ascending/descending rod 20 is coupled to the pulling rod 10 of the eccentric mechanism 1, and the other ascending/descending rod 21 is secured to a prop rod 30 of the fixed rod module 3.

The fixed rod module 3 comprises a prop rod 30 and a fixed rod 31, and one side of the prop rod 30 is secured to the ascending/descending rod 21 and the other side secured to the fixed rod 31.

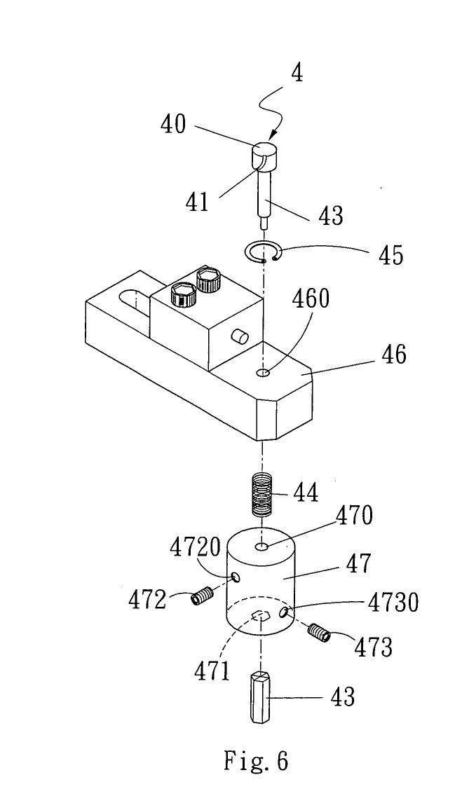

The probe module 4 comprises a probe rotary head 40 on one side, and a probe rotary rod 42 having a groove 41 on its periphery, a screw testing head 43, a spring 44, a latch ring 45, a lock member 46 and a screw testing head fixed member 47 as shown in FIGS. 6 and 7. In the figures, a probe rotary rod 42 of a probe rotary head with a latch ring 45 passes through a lock hole 460 of a lock member 46, and is sheathed with a spring 44 as to secure one end of the screw testing head fixed member 47 into the lock hole 470 and the other end of the screw testing head fixed member 47 into a hole 471 for installing a screw testing head 43, and then the screw members 472, 473 are screwed and fixed separately into the screw holes 4720, 4730 at the upper and lower intersections of periphery of the screw testing head fixed member 47 by screws in order to secure the probe module 4 to a measuring platform C.

Please refer to FIG. 3. When the screw 5 falls from the screw tray 7 to the screw rotary tray 70, the screw rotary tray 70 will rotate the screw 5 to a measuring position, and a camera 8 will project an image 53 of the screw 5 onto the computer screen as shown in FIG. 10 to measure the depth 520 of the polygonal hole 52 of the screw, the length 54 of the neck section, the serration length 55, screw pitch 56 and thread angle 57 at a time.

What is claimed is:

1. A screw head press detector, comprising:
an eccentric mechanism, being disposed on one side of a base of said screw press detector;
an ascending/descending rod module, having an ascending/descending pull rod with both ends secured respectively to two ascending/descending rods;
a fixed rod module, having a prop rod and a fixed rod;
a probe module, comprising a probe rotary rod of a probe rotary head having a latch ring being disposed thereon, and collocating with a spring and a latch ring, and being secured into a lock hole of a lock member and coupled with a lock hole of a fixed member of a screw testing head, and one side of said fixed member of said screw testing head being secured to said screw testing head, such that said eccentric mechanism rotates to drive said ascending/descending rod module to press said probe module down and use a groove of said probe rotary head to rotate and fix a screw at the same angle with a polygonal hole of said screw as to facilitate detecting the depth of a polygonal hole of said screw head, and push said fixed rod up to push said fixed screw upward to facilitate measuring the length of a screw neck section, a screw pitch, a screw thread angle and a distance between the bottom of said screw head and said screw thread.

2. The screw head press detector of claim 1, wherein said eccentric mechanism is coupled secured to an eccentric mechanism pulling rod.

3. The screw head press detector of claim 1, wherein said ascending/descending module comprises two ascending/descending rods and an ascending/descending pulling rod, and both ends of said ascending/descending pulling rod are secured respectively with two ascending/descending rods, and one end of said ascending/descending rod is coupled with said eccentric mechanism pulling rod, and the other ascending/descending rod is secured with said prop rod of said fixed rod module.

4. The screw head press detector of claim 1, wherein said prop rod with one side securely coupled to said ascending/descending rod of said ascending/descending rod module and the other side securely coupled to said fixed rod.

5. The screw head press detector of claim 1, wherein said lock hole of said lock member is penetrating.

6. The screw head press detector of claim 1, wherein said fixed member of said screw testing head comprises a locking hole disposed at one end and a hole evacuated from the other end.

7. The screw head press detector of claim 6, wherein said hole has the same shape as said screw testing head.

8. The screw head press detector of claim 6, wherein said fixed member of said screw testing head comprises a screw hole individually disposed at the upper and lower intersections of the periphery and a screw device is screwed into said screw hole to press against said probe rotary rod and said screw testing head.
